(19) United States
(12) Patent Application Publication
(10) Pub. No.: US 2026/0177686 A1
(43) Pub. Date: Jun. 25, 2026

(54) RADAR SYSTEM INCLUDING MULTIPLE RADARS AND SIGNAL TRANSMITTING AND RECEIVING METHOD THEREOF

(71) Applicant: ELECTRONICS AND TELECOMMUNICATIONS RESEARCH INSTITUTE, Daejeon (KR)

(72) Inventors: Hyunseok KIM, Daejeon (KR); Kyung Hwan PARK, Daejeon (KR); Seonjeong PARK, Daejeon (KR); Ja Yol LEE, Daejeon (KR)

(21) Appl. No.: 19/416,068

(22) Filed: Dec. 11, 2025

(30) Foreign Application Priority Data
Dec. 19, 2024 (KR) 10-2024-0191741

(51) Int. Cl. G01S 13/87; G01S 7/35

(52) U.S. Cl. CPC G01S 13/87; G01S 7/352

(57) ABSTRACT

In a radar system including a plurality of networked radars, each of the plurality of networked radars includes a transmission-signal time delay device configured to delay a transmission signal in time and a reception-signal time delay device configured to delay a reception signal in time, a time delayed by the reception-signal time delay device is equal to a time delayed by the transmission-signal time delay device, a transmission-signal time delay device and a reception-signal time delay device of a first radar, which is located farthest from a detection target among the plurality of radars, are turned off, and transmission-signal time delay devices and reception-signal time delay devices of remaining radars, which are the radars other than the first radar among the plurality of radars, are all turned on.

### CROSS-REFERENCE TO RELATED APPLICATIONS

This application claims priority under 35 U.S.C. § 119 to Korean Patent Application No. 10-2024-0191741 filed on Dec. 19, 2024, in the Korean Intellectual Property Office, the disclosure of which is incorporated by reference herein in its entirety.

### BACKGROUND

### 1. Field of the Invention

The present disclosure relates to a radar system including a plurality of a plurality of radars and a signal transmitting and receiving method thereof.

### 2. Description of Related Art

Microwave-based radar technology has been rapidly applied in daily life in recent years along with advances in semiconductor chip design. In particular, in the field of automobiles, radar is used in various applications such as preventing collisions between vehicles and detecting occupants. In disaster environments, a through-wall radar can be usefully employed to detect human presence inside a building when a fire or earthquake occurs. This can greatly assist firefighters in detecting people in dangerous situations. Thus, radar technology not only enhances convenience in everyday life but also plays an important role in improving public safety.

To determine whether there is a victim to be rescued behind a wall, it is necessary to greatly amplify the transmission signal of a through-wall radar so that it can penetrate the wall, but this is an inefficient and ineffective approach. If a radar technology that distributes multiple radars and coherently synthesizes their transmit and reception signals is employed, power and cost efficiency can be improved. However, unlike an Impulse Radio-Ultrawideband (IR-UWB) radar, a reception signal of a Frequency-Modulated Continuous Wave (FMCW) radar does not directly include distance information, so signal processing for extracting distance information, i.e., a Fast Fourier Transform (FFT) process, is required after demodulation. Accordingly, a receive coherent synthesis process must be performed before the FFT.

### SUMMARY

The present disclosure is directed to providing a radar system including a plurality of networked radars and a signal transmitting and receiving method thereof, and discloses an FMCW radar transceiver structure and an operation method thereof that are required to perform a transmit/receive coherent synthesis function based on FMCW radar.

According to an embodiment of the present disclosure, in a radar system including a plurality of networked radars, each of the plurality of radars comprises a transmission-signal time delay device configured to delay a transmission signal in time and a reception-signal time delay device configured to delay a reception signal in time. A time delayed by the reception-signal time delay device is equal to a time delayed by the transmission-signal time delay device. The transmission-signal time delay device and the reception-signal time delay device of a first radar, which is located farthest from a detection target among the plurality of radars, are turned off. The transmission-signal time delay devices and the reception-signal time delay devices of remaining radars, which are the radars other than the first radar among the plurality of radars, are all turned on.

In one embodiment, each of the plurality of radars further includes a signal generator, a transmission signal amplifier, and a transmission antenna, wherein a transmission-signal time delay device that is turned on time-delays a signal output from the signal generator, the transmission signal amplifier amplifies the time-delayed signal by the transmission-signal time delay device that is turned on, and the signal amplified by the transmission signal amplifier may be radiated from the transmission antenna.

In one embodiment, each of the plurality of radars further includes a reception antenna, a reception signal amplifier, and a mixer, wherein the reception antenna receives a signal reflected from the detection target, the reception signal amplifier amplifies the received signal, a reception-signal time delay device that is turned on time-delays the signal amplified by the reception signal amplifier, and the mixer demodulates the signal output from the signal generator and the signal time-delayed by the reception-signal time delay device that is turned on.

In one embodiment, the plurality of radars may be FMCW radars.

In one embodiment, in the remaining radars, which are the radars other than the first radar among the plurality of radars, a value of the time delayed by the reception-signal time delay devices may be a value that compensates for beat frequencies, which are FFT (Fast Fourier Transform) results of signal processing of the remaining radars, to become equal to a beat frequency that is a signal processing result of the first radar.

In one embodiment, the remaining radars, which are the radars other than the first radar among the plurality of radars, include a second radar located at a first detection distance from the detection target and a third radar located at a second detection distance from the detection target, the first detection distance is greater than the second detection distance, and a value of the time delayed by a receive time delay unit of the second radar may be smaller than a value of the time delayed by a receive time delay unit of the third radar.

According to an embodiment of the present disclosure, a signal transmitting and receiving method of a radar system including a plurality of networked radars includes transmitting signals from the plurality of radars to a detection target and receiving, by the plurality of radars, signals reflected from the detection target, wherein, in the transmitting of the signals from the plurality of radars to the detection target, a transmission-signal time delay device of a first radar, which is located farthest from the detection target among the plurality of radars, is turned off, and transmission-signal time delay devices of remaining radars, which are the radars other than the first radar among the plurality of radars, are all turned on, and in the receiving of the signals reflected from the detection target by the plurality of radars, a reception-signal time delay device of the first radar is turned off and reception-signal time delay devices of the remaining radars, which are the radars other than the first radar among the plurality of radars, are all turned on, and times delayed by the reception-signal time delay devices that are turned on are equal to times delayed by the transmission-signal time delay devices that are turned on.

In one embodiment, the transmitting of the signals from the plurality of radars to the detection target may include, in the first radar, amplifying a signal generated by a signal generator and transmitting the amplified signal through a transmission antenna, and, in the remaining radars, which are the radars other than the first radar among the plurality of radars, time-delaying signals generated by signal generators by the transmission-signal time delay devices, amplifying the time-delayed signals, and transmitting the amplified signals through transmission antennas.

In one embodiment, the receiving of the signals reflected from the detection target by the plurality of radars may include, in the first radar, amplifying a signal received from a reception antenna and demodulating a signal generated by the signal generator and the amplified signal by a mixer, and, in the remaining radars, which are the radars other than the first radar among the plurality of radars, amplifying signals received from reception antennas, time-delaying the amplified signals by the reception-signal time delay devices, and demodulating signals generated by signal generators and the time-delayed signals by mixers.

In one embodiment, in the remaining radars, which are the radars other than the first radar among the plurality of radars, a value of the time delayed by the reception-signal time delay devices may be a value that compensates beat frequencies of the remaining radars to become equal to a beat frequency of the first radar.

In one embodiment, the remaining radars, which are the radars other than the first radar among the plurality of radars, include a second radar located at a first detection distance from the detection target and a third radar located at a second detection distance from the detection target, the first detection distance is greater than the second detection distance, and a value of the time delayed by a receive time delay unit of the second radar may be smaller than a value of the time delayed by a receive time delay unit of the third radar.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a radar system according to an embodiment of the present disclosure.

FIG. 2 illustrates a radar system including a plurality of networked radars according to an embodiment of the present disclosure.

FIG. 3 is a block diagram illustrating in detail an internal structure of a radar according to an embodiment of the present disclosure.

FIG. 4 is a flowchart illustrating a signal transmitting and receiving method of a radar system including a plurality of networked radars according to an embodiment of the present disclosure.

FIG. 5 is a flowchart illustrating detailed steps included in step S100 of FIG. 4.

FIG. 6 is a flowchart illustrating detailed steps included in step S200 of FIG. 4.

### DETAILED DESCRIPTION

Hereinafter, embodiments of the present disclosure will be described in detail and clearly to such an extent that an ordinary one in the art easily implements the present disclosure.

The terms “unit”, “module”, and the like used hereinafter, and functional blocks shown in the drawings, may be implemented in the form of a software configuration, a hardware configuration, or a combination thereof. In the following description, detailed descriptions of duplicate components are omitted in order to clearly explain the technical spirit of the present disclosure.

In the present document, each of the phrases “A or B”, “at least one of A and B”, “at least one of A or B”, “A, B, or C”, “at least one of A, B, and C”, and “at least one of A, B, or C” may include any one of the items listed together in the relevant phrase, or any possible combination of all of them.

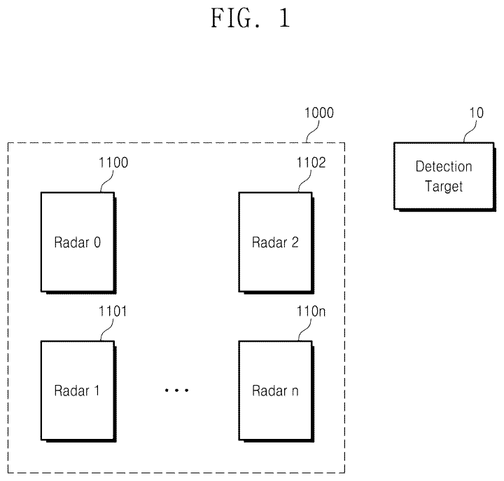

FIG. 1 is a block diagram illustrating a radar system according to an embodiment of the present disclosure. Referring to FIG. 1, a radar system 1000 may include a plurality of networked radars 1100 to 110n. Each of the plurality of radars 1100 to 110n may include a zeroth radar 1100 and first through nth radars 1101 to 110n. Through FIG. 1, the radar system according to an embodiment of the present disclosure will be described in detail.

The radar system 1000 may be a system for finding a detection target 10. For example, the radar system 1000 may be used for various purposes. For example, the radar system 1000 may be included in systems for detecting a person or the like indoors, systems for navigation devices, military systems, or fish finding systems. The detection target 10 is a target to be detected by the radar system 1000 and may be different depending on the purpose of the radar system 1000. For example, when the radar system 1000 is a military system, the detection target 10 may be equipment, a radar, or the like of friendly forces or enemy forces.

The radars 1100 to 110n may each detect the detection target 10. In one embodiment, the radars 1100 to 110n may be implemented as a distributed coherent radar technology, i.e., a network-based radar technology configured with a plurality of separated transmitters and receivers.

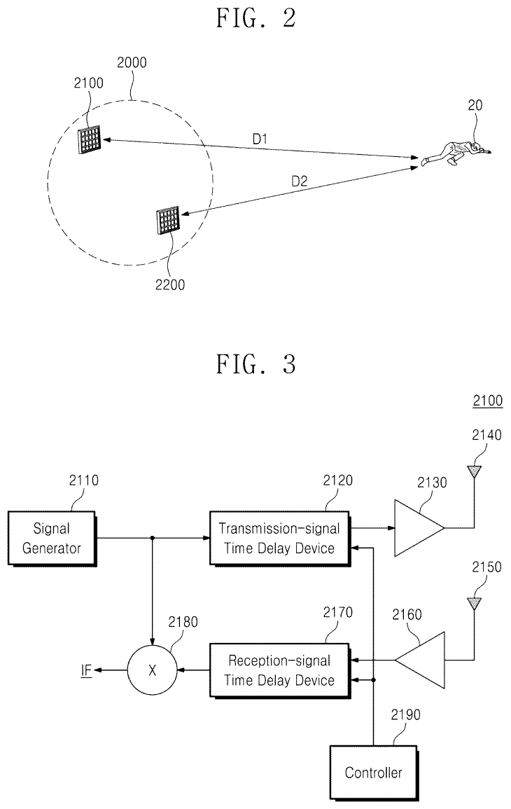

In one example, the radars 1100 to 110n may be FMCW radars. To detect the detection target 10, the radars 1100 to 110n may radiate coherently synthesized transmission signals. The coherently synthesized transmission signals are reflected by the detection target 10, and the radars 1100 to 110n receive the signals and output coherently synthesized reception signals through a synthesized signal processing procedure. A signal transmitting and receiving procedure of the radars 1100 to 110n of the radar system 1000 will be described in further detail with reference to FIGS. 2 to 4. Including the radar system 1000 of FIG. 1, radar systems described hereinafter may be distributed coherent radar systems for coherent synthesis of transmit and reception signals.

The arrangement of the radars 1100 to 110n shown and described with reference to FIG. 1 is merely exemplary, and the scope of the present disclosure should not be limited thereto. It should be understood that embodiments in which the radars 1100 to 110n are arranged at arbitrary distances or in arbitrary distributions also fall within the scope of the present disclosure.

FIG. 2 illustrates a radar system including a plurality of networked radars according to an embodiment of the present disclosure. A radar system 2000 of FIG. 2 may correspond to the radar system of FIG. 1. The radar system 2000 may include a plurality of networked radars, and, in FIG. 2, only a first radar 2100 and a second radar 2200 are illustratively shown. The first radar 2100 may be a radar that is located farthest from a detection target 20 among the plurality of radars included in the radar system 2000. That is, among the radars included in the radar system 2000, the radar 2100 located at a detection distance D1 that is farthest from the detection target 20 is shown in FIG. 2. The second radar 2200 may be located closer to the detection target 20 than the first radar 2100.

In one example, when a distributed coherent synthesis technology is applied to the first radar 2100 and the second radar 2200, an issue of primary concern is a problem with receive coherent synthesis. Reception signals in an FMCW radar do not themselves include distance information, and distance information is derived through signal processing, that is, an FFT, from a demodulated signal. Since FFT results of the radars 1100 to 110n are already signal-processed results, they do not have an effect of synthesis. To address this, demodulated signals, which are in a signal form before signal processing, need to be synthesized. However, since the demodulated signals include different distance information from the target point, a technology is required in which the demodulated signals share the same distance information with respect to the target point. Hereinafter, detailed components of the radar and an operation method of radars included in the radar system for this purpose will be described in detail.

FIG. 3 is a block diagram illustrating in detail a radar according to an embodiment of the present disclosure. FIG. 3 will be described together with FIGS. 1 and 2. A radar 2100 of FIG. 3 may include a signal generator 2110, a transmission-signal time delay device 2120, a transmit amplifier 2130, a transmission antenna 2140, a reception antenna 2150, a receive amplifier 2160, a reception-signal time delay device 2170, a mixer 2180, and a controller 2190. Although FIG. 3 is shown as illustrating in detail the radar 2100 of FIG. 2, the radars included in the radar system 2000 of FIG. 2 may all be implemented to have the same structure as the radar 2100 of FIG. 3.

In one example, the radar 2100 of FIG. 3 may be an FMCW radar. In this case, the signal generator 2110 may be an FMCW signal generator and may generate a signal whose frequency linearly increases with time or a signal whose frequency linearly decreases with time, i.e., a chirp signal. The radars included in the radar system 2000 may use the same signal generator, and therefore, a rate of change of frequency increasing or decreasing with time may be the same in all radars in the radar system.

The transmission-signal time delay device 2120 may time-delay a signal output from the signal generator 2110. A value of the time delayed by the transmission-signal time delay device 2120 may be determined in advance, or may be determined by the controller 2190 based on a position of the radar 2100. The transmission-signal time delay device 2120 may be turned on or turned off by the controller 2190. For example, the controller 2190 may turn on or turn off the transmission-signal time delay device 2120 based on whether the radar 2100 is the radar that is located farthest from the detection target 20 among the radars included in the radar system 2000. In one example, a transmission-signal time delay device of a first radar (for example, 2100 of FIG. 2), which is located farthest from the detection target among the plurality of radars, is turned off, and transmission-signal time delay devices of remaining radars, which are the radars other than the first radar among the plurality of radars, are all turned on. That is, in the radar system 1000 or 2000, in a radar that is located farthest from the detection target among the plurality of radars, a signal may not be time-delayed even when it passes through the corresponding transmission-signal time delay device. In addition, in the radar system 1000 or 2000, in the remaining radars, which are the radars other than the first radar among the plurality of radars, a signal may be time-delayed as it passes through the corresponding transmission-signal time delay device. Whether a signal passing through a transmission-signal time delay device 2120 that is turned on is time-delayed and by how much may be based on the position (detection distance from the detection target) of each radar.

The transmit amplifier 2130 may amplify a transmission signal that is time-delayed or not time-delayed, and the transmission antenna 2140 may radiate the amplified transmission signal. The radiated transmission signal may reach the detection target 20. In one example, the transmit amplifier 2130 may be a power amplifier (PA).

The reception antenna 2150 may receive a signal reflected from the detection target. The receive amplifier 2160 may amplify the received signal and output the amplified signal. In one example, the receive amplifier 2160 may be a low noise amplifier (LNA).

The reception-signal time delay device 2170 may time-delay a signal output from the receive amplifier 2160. A value of the time delayed by the reception-signal time delay device 2170 may be determined in advance, or may be determined by the controller 2190 based on the position of the radar 2100. In either case, a time delayed by the reception-signal time delay device 2170 may be equal to a time delayed by the transmission-signal time delay device 2120. The reception-signal time delay device 2170 may be turned on or turned off by the controller 2190. For example, the controller 2190 may turn on or turn off the reception-signal time delay device 2170 based on whether the radar 2100 is the radar that is located farthest from the detection target 20 among the radars included in the radar system 2000.

The mixer 2180 may demodulate the signal output from the signal generator 2110 and the signal time-delayed by the reception-signal time delay device that is turned on (in the first radar 2100 that is located farthest from the detection target among the plurality of radars). Alternatively, the mixer 2180 may demodulate the signal output from the signal generator 2110 and a signal that has passed through a reception-signal time delay device that is turned off but is not time-delayed (in the remaining radars, which are the radars other than the first radar among the plurality of radars). A demodulated signal (an IF signal) of the mixer 2180 may be output. In one example, the demodulated IF signal may include information about a position (or distance) of the detection target 20 and/or information about a detection distance of the radar 2100 from the detection target 20.

The radar system according to an embodiment of the present document is for transmit and receive coherent synthesis that satisfies both transmit coherent synthesis and receive coherent synthesis, and may be implemented such that the plurality of radars included in the radar system can share the same distance information based on time delay units of the plurality of radars. That is, in an embodiment of the present document, in the remaining radars, which are the radars other than the first radar among the plurality of radars, transmit and reception signals are equally time-delayed so that all radars, including the first radar that is located farthest from the detection target, share the same distance information. For example, when the radars included in the plurality of radar systems are FMCW radars, the fact that all radars share the same distance information may mean that all FMCW radars have the same beat frequency. Accordingly, all radars complete demodulated IF signals in an arbitrary device without performing an FFT, and a single FFT is performed.

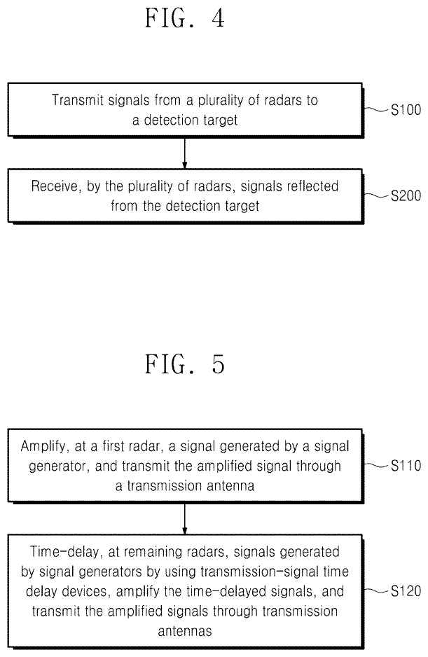

FIG. 4 is a flowchart illustrating a signal transmitting and receiving method of a radar system including a plurality of networked radars according to an embodiment of the present disclosure. FIG. 4 may be described together with FIGS. 1 to 3.

In step S100, the plurality of radars may transmission signals to the detection target.

In step S200, the plurality of radars may reception signals reflected from the detection target.

In an embodiment to which the above steps are applied, in step S100, the transmission-signal time delay device of the first radar, which is located farthest from the detection target among the plurality of radars, may be turned off, and the transmission-signal time delay devices of the remaining radars, which are the radars other than the first radar among the plurality of radars, may all be turned on. For example, when a transmission-signal time delay device is turned off, a signal may not be time-delayed even when it passes through the corresponding transmission-signal time delay device, and when a transmission-signal time delay device is turned on, a signal may be time-delayed as it passes through the corresponding transmission-signal time delay device. Whether a signal passing through a transmission-signal time delay device that is turned on is time-delayed and by how much may be based on the position (detection distance from the detection target) of each radar.

In an embodiment to which the above steps are applied, in step S100, the reception-signal time delay device of the first radar may be turned off, and the reception-signal time delay devices of the remaining radars, which are the radars other than the first radar among the plurality of radars, may all be turned on. For example, when a reception-signal time delay device is turned off, a signal may not be time-delayed even when it passes through the corresponding reception-signal time delay device, and when a reception-signal time delay device is turned on, a signal may be time-delayed as it passes through the corresponding reception-signal time delay device. Whether a signal passing through a reception-signal time delay device that is turned on is time-delayed and by how much may be based on the position (detection distance from the detection target) of each radar.

In one example, the time delayed by the reception-signal time delay devices that are turned on may be equal to the time delayed by the transmission-signal time delay devices that are turned on. This is to make beat frequencies of the plurality of radars included in the radar system coincide.

FIG. 5 is a flowchart illustrating detailed steps included in step S100 of FIG. 4. FIG. 5 may be described together with FIGS. 1 to 4. Step S100 of FIG. 4 may include steps S110 and S120 of FIG. 5.

In step S110, the first radar may amplify a signal generated by a signal generator included in the first radar (by a transmit amplifier included in the first radar), and may transmit the amplified signal through a transmission antenna included in the first radar.

In step S120, the remaining radars, which are the radars other than the first radar among the plurality of radars, may time-delay signals generated by signal generators included in the radars by transmission-signal time delay devices included in the radars, amplify the time-delayed signals (by transmit amplifiers included in the radars), and transmit the amplified signals through transmission antennas included in the radars.

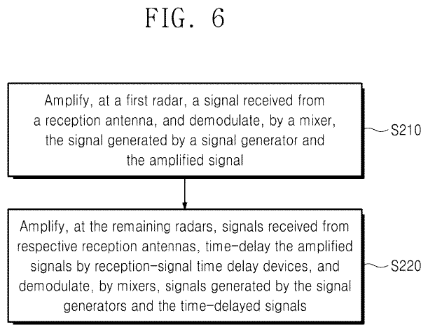

FIG. 6 is a flowchart illustrating detailed steps included in step S200 of FIG. 4. FIG. 6 may be described together with FIGS. 1 to 5. Step S200 of FIG. 4 may include steps S210 and S220 of FIG. 6.

In step S210, the first radar may amplify a signal received from a reception antenna included in the first radar (by a receive amplifier included in the first radar), and may demodulate a signal generated by the signal generator included in the first radar and the amplified signal by a mixer included in the first radar.

In step S220, the remaining radars, which are the radars other than the first radar among the plurality of radars, may amplify signals received from reception antennas included in the radars (by receive amplifiers included in the radars), time-delay the amplified signals by reception-signal time delay devices included in the radars, and demodulate signals generated by signal generators and the time-delayed signals by mixers.

In the signal transmitting and receiving method of the radar system according to the embodiment described together with FIGS. 4 to 6, in the remaining radars, which are the radars other than the first radar among the plurality of radars, a value of the time delayed by the reception-signal time delay devices may be a value that compensates beat frequencies of the remaining radars to become equal to a beat frequency of the first radar.

In the signal transmitting and receiving method of the radar system according to the embodiment described together with FIGS. 4 to 6, the remaining radars, which are the radars other than the first radar among the plurality of radars, may include a second radar located at a first detection distance from the detection target and a third radar located at a second detection distance from the detection target. In one example, the first detection distance may be greater than the second detection distance. For example, a value of the time delayed by a receive time delay unit of the second radar may be smaller than a value of the time delayed by a receive time delay unit of the third radar.

The above description constitutes specific embodiments for carrying out the present disclosure. The present disclosure includes not only the above-described embodiments but also embodiments that are simply modified in design or can be easily modified. In addition, the present disclosure includes techniques that can be easily modified and implemented using the embodiments. Therefore, the scope of the present disclosure should not be limited to the above-described embodiments and should be defined by the claims described below and their equivalents.

What is claimed is:

1. A radar system including a plurality of networked radars, each of the plurality of networked radars comprising:
a transmission-signal time delay device configured to delay a transmission signal in time; and
a reception-signal time delay device configured to delay a reception signal in time,
wherein a time delayed by the reception-signal time delay device is equal to a time delayed by the transmission-signal time delay device,
wherein a transmission-signal time delay device and a reception-signal time delay device of a first radar, which is located farthest from a detection target among the plurality of radars, are turned off, and
wherein transmission-signal time delay devices and reception-signal time delay devices of remaining radars, which are the radars other than the first radar among the plurality of radars, are all turned on.

2. The radar system of claim 1, wherein each of the plurality of networked radars further includes:
a signal generator;
a transmission signal amplifier; and
a transmission antenna,
wherein a transmission-signal time delay device that is turned on time-delays a signal output from the signal generator, the transmission signal amplifier amplifies the signal time-delayed by the transmission-signal time delay device that is turned on, and the signal amplified by the transmission signal amplifier is radiated from the transmission antenna.

3. The radar system of claim 2, wherein each of the plurality of networked radars further includes:
a reception antenna;
a reception signal amplifier; and
a mixer,
wherein the reception antenna receives a signal reflected from the detection target, the reception signal amplifier amplifies the received signal, a reception-signal time delay device that is turned on time-delays the signal amplified by the reception signal amplifier, and the mixer demodulates the signal output from the signal generator and the signal time-delayed by the reception-signal time delay device that is turned on.

4. The radar system of claim 1, wherein the plurality of networked radars are Frequency Modulation Continuous Wave (FMCW) radars.

5. The radar system of claim 1, wherein, in remaining radars, which are the radars other than the first radar among the plurality of networked radars, a value of the time delayed by the reception-signal time delay devices is a value that compensates beat frequencies of the remaining radars to become equal to a beat frequency of the first radar.

6. The radar system of claim 5,
wherein the remaining radars, which are the radars other than the first radar among the plurality of radars, include a second radar located at a first detection distance from the detection target and a third radar located at a second detection distance from the detection target,
wherein the first detection distance is greater than the second detection distance, and
wherein a value of the time delayed by a receive time delay unit of the second radar is smaller than a value of the time delayed by a receive time delay unit of the third radar.

7. A signal transmitting and receiving method of a radar system including a plurality of networked radars, the method comprising:
transmitting signals from the plurality of radars to a detection target; and
receiving, by the plurality of radars, signals reflected from the detection target,
wherein, in the transmitting of the signals from the plurality of radars to the detection target, a transmission-signal time delay device of a first radar, which is located farthest from the detection target among the plurality of radars, is turned off, and transmission-signal time delay devices of remaining radars, which are the radars other than the first radar among the plurality of radars, are all turned on,
wherein, in the receiving of the signals reflected from the detection target by the plurality of radars, a reception-signal time delay device of the first radar is turned off and reception-signal time delay devices of the remaining radars, which are the radars other than the first radar among the plurality of radars, are all turned on, and
wherein times delayed by the reception-signal time delay devices that are turned on are equal to times delayed by the transmission-signal time delay devices that are turned on.

8. The method of claim 7, wherein the transmitting of the signals from the plurality of networked radars to the detection target comprises:
wherein, in the first radar, amplifying a signal generated by a signal generator and transmitting the amplified signal through a transmission antenna; and
wherein, in remaining radars, which are the radars other than the first radar among the plurality of radars, time-delaying signals generated by signal generators by transmission-signal time delay devices, amplifying the time-delayed signals, and transmitting the amplified signals through transmission antennas.

9. The method of claim 8,
wherein the receiving of the signals reflected from the detection target by the plurality of networked radars comprises:
wherein, in the first radar, amplifying a signal received from a reception antenna and demodulating a signal generated by a signal generator and the amplified signal by a mixer; and
wherein, in remaining radars, which are the radars other than the first radar among the plurality of radars, amplifying signals received from reception antennas, time-delaying the amplified signals by reception-signal time delay devices, and demodulating signals generated by signal generators and the time-delayed signals by mixers.

10. The method of claim 9, wherein, in remaining radars, which are the radars other than the first radar among the plurality of networked radars, a value of the time delayed by the reception-signal time delay devices is a value that compensates beat frequencies of the remaining radars to become equal to a beat frequency of the first radar.

11. The method of claim 10, wherein the remaining radars, which are the radars other than the first radar among the plurality of networked radars, include a second radar located at a first detection distance from the detection target and a third radar located at a second detection distance from the detection target,
wherein the first detection distance is greater than the second detection distance, and
wherein a value of the time delayed by a receive time delay unit of the second radar is smaller than a value of the time delayed by a receive time delay unit of the third radar.
